(19) United States
(12) Patent Application Publication
(10) Pub. No.: US 2013/0201380 A1
(43) Pub. Date: Aug. 8, 2013

(54) OPTICAL IMAGING SYSTEM AND PORTABLE TERMINAL HAVING THE SAME

(71) Applicant: Samsung Electronics Co., Ltd., Gyeonggi-do (KR)

(72) Inventor: Sung-Wook CHOI, Gyeonggi-do (KR)

(73) Assignee: Samsung Electronics Co., Ltd., Gyeonggi-do (KR)

(21) Appl. No.: 13/758,352

(22) Filed: Feb. 4, 2013

(30) Foreign Application Priority Data
Feb. 7, 2012 (KR) 10-2012-0012290

(51) Int. Cl. G02B 3/00

(52) U.S. Cl. CPC G02B 3/00
USPC 348/340; 359/784

(57) ABSTRACT

An optical imaging system is provided, including a first lens having a positive (+) refractive power, a second lens having a positive (+) or negative (−) refractive power positioned at the rear of the first lens, and a third lens having a positive (+) or negative (−) refractive power positioned at the rear of the second lens, in which the first lens is a heterogeneous cemented lens in which a first sub lens and a second sub lens which have different dispersion values are integrally coupled to each other.

### PRIORITY

This application claims priority under 35 U.S.C. §119(a) to a Korean Patent Application filed in the Korean Intellectual Property Office on Feb. 7, 2012 and assigned Serial No. 10-2012-0012290, the entire disclosure of which is hereby incorporated by reference.

### BACKGROUND OF THE INVENTION

1. Field of the Invention

The present invention generally relates to an optical imaging system, and more particularly, to a subminiature optical imaging system which is mounted on a portable terminal to provide higher resolution and higher quality than a conventional optical system, and which can be manufactured at low cost.

2. Description of the Related Art

Generally, early portable phones merely provided communication functions, but with the increasing use of the portable phones, required services, such as photographing, image transmission, and image communication, have now become common, and these functions and services of the portable phones have evolved over and over again. Recently, portable phones now have integrated digital camera techniques and portable phone techniques, that is, so-called camera phones or camera mobile phones have attracted much attention.

In particular, small size/light weight/low cost for an optical imaging system mounted on the camera phone have been strongly demanded, and as the pixel size of an image sensor such as a Charge-Coupled Device (CCD) or a Complementary Metal-Oxide Semiconductor (CMOS) decreases, a higher resolution for the optical imaging system using the image sensor is needed. For the optical imaging system mounted on a small-size device such as a portable phone, the number of lenses needs to be reduced to satisfy small size/low cost concerns; in this case, however, the degree of freedom of design is reduced and optical performance is difficult to meet. In particular, a conventional optical imaging system has some problems in terms of small size/light weight because there is a limitation in the thickness of a single lens of the optical imaging system.

Therefore, a need exists for a subminiature optical imaging system which has high resolution, excellent aberration performance, and allows for small size/light weight.

### SUMMARY OF THE INVENTION

Particular embodiments of the present invention are intended to at least partially solve, alleviate, or remove the problems and/or disadvantages associated with conventional techniques.

Accordingly, the present invention provides a subminiature optical imaging system which is mounted on a portable terminal, such as a portable phone, to provide higher resolution and higher quality than a conventional optical system, and which allows small size/light weight/low cost.

According to an aspect of the present invention, there is provided an optical imaging system including a first lens having a positive (+) refractive power, a second lens having a positive (+) or negative (−) refractive power positioned at the rear of the first lens, and a third lens having a positive (+) or negative (−) refractive power positioned at the rear of the second lens, in which the first lens is a heterogeneous cemented lens in which a first sub lens and a second sub lens which have different dispersion values are integrally coupled to each other.

According to another aspect of the present invention, there is provided a portable terminal for providing a photographing function, the portable terminal having an optical imaging system, the optical imaging system including a first lens having a positive (+) refractive power, a second lens having a positive (+) or negative (−) refractive power positioned at the rear of the first lens, and a third lens having a positive (+) or negative (−) refractive power positioned at the rear of the second lens, in which the first lens is a heterogeneous cemented lens in which a first sub lens and a second sub lens which have different dispersion values are integrally coupled to each other.

### BRIEF DESCRIPTION OF THE DRAWINGS

The above and other features and advantages of embodiments of the present invention will be more apparent from the following detailed description taken in conjunction with the accompanying drawings, in which:

FIG. 1 is a diagram illustrating a structure of an optical imaging system according to a Comparative Example with respect to the present invention;

FIG. 2 is a diagram illustrating a ray tracing simulation result when an optical imaging system according to the Comparative Example photographs an object;

FIG. 3 is a diagram illustrating Modulation Transfer Function (MTF) curves of an optical imaging system based on a simulation of the Comparative Example;

FIG. 4 is a diagram illustrating a structure of an optical imaging system according to an embodiment of the present invention;

FIG. 5 is a diagram illustrating a ray tracing simulation result when an optical imaging system according to an embodiment of the present invention photographs an object; and

FIG. 6 is a diagram illustrating MTF curves of an optical imaging system based on a simulation of an embodiment of the present.

### DETAILED DESCRIPTION OF THE EMBODIMENTS OF THE PRESENT INVENTION

Hereinafter, embodiments of the present invention will be described with reference to the accompanying drawings. In the following description, specific details such as a detailed configuration and components are merely provided to assist the overall understanding of the embodiments of the present invention and predetermined changes or modifications can be made without departing from the scope of the present invention. In addition, a detailed description of well-known functions and constructions will not be provided if they unnecessarily obscure the subject matter of the present invention.

Although ordinal numbers such as “first”, “second”, and so forth will be used in an embodiment described below, they are merely intended to distinguish objects having the same name, their order may be set arbitrarily, and the preceding description of an object may be applied to a next-order object.

To facilitate understanding, a prior art embodiment of an optical imaging system will be described, and will hereinafter be referred to as a “Comparative Example.” The Comparative Example with respect to the present invention will be described first, and an embodiment of the present invention will then be described.

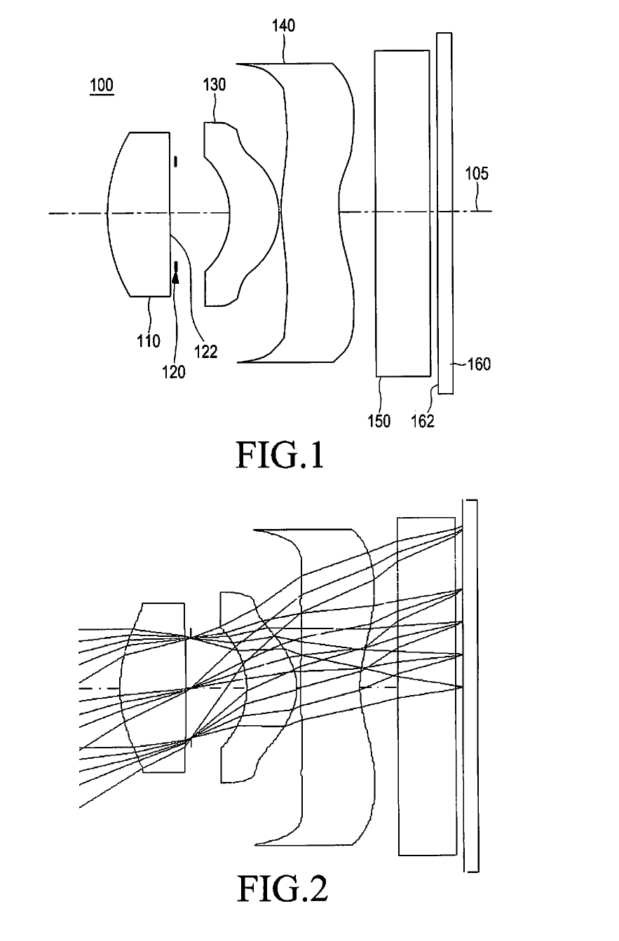

FIG. 1 is a diagram illustrating a structure of an optical imaging system 100 according to the Comparative Example with respect to the present invention, and FIG. 2 is a diagram illustrating a ray tracing simulation result when the optical imaging system 100 according to the Comparative Example photographs an object.

The optical imaging system 100 includes a first lens 110, an iris 120, second and third lenses 130 and 140, an Infrared (IR) cut-off filter 150, and an image sensor 160, which are aligned on an optical axis 105.

The first, second, and third lenses 110, 130, and 140 form an image of an object positioned within their angles of view on a light-receiving surface 162 of the image sensor 160, and the IR cut-off filter 150 cuts off an IR signal passing through the first, second, and third lenses 110, 130, and 140. The image sensor 160 converts an optical image formed by light passing through the IR cut-off filter 150 into an electric image signal.

Table 1 provided below shows numeric data of optical devices of the optical imaging system 100. Table 1 shows a surface number i, a radius of curvature R of an i^{th} optical surface Sᵢ, a thickness or air interval of the i^{th} optical surface (or a distance from the i^{th} optical surface to an (i+1)^{th} optical surface), T, a refractive index n_{d} in a d-line (587.5618 nm) of the i^{th} optical surface, and a dispersion value in the d-line of the i^{th} optical surface, that is, an Abbe's number, V_{d}. The unit for the radius of curvature and the thickness is mm. The optical surface number i is sequentially added in a direction from the object toward the image sensor (that is, an image surface). For example, in the first lens 110, the first optical surface may be an object-side optical surface and the second optical surface may be an image-side optical surface. The mark “*” in front of the optical surface number i indicates that the corresponding optical surface is aspherical, and the other optical surfaces are spherical. The object is assumed to be a round object situated at infinity. The iris 120 has a circular opening 122.

TABLE 1

| | Radius of | | | Abbe's | |
|---|---|---|---|---|---|
| Surface | Curvature | Surface | Refractive | No. | |
| Number | (R) | Interval | Index (n_{d}) | (V_{d}) | Remarks |
| *1 | 0.950771 | 0.45742 | 1.55 | 56 | First Lens |
| *2 | ∞ | 0.030571 | | | |
| 3 | ∞ | 0.38661 | | | Iris |
| *4 | −0.63239 | 0.351867 | 1.55 | 56 | Second Lens |
| *5 | −0.41228 | 0.03 | | | |
| *6 | 7.790652 | 0.410947 | 1.55 | 56 | Third Lens |
| *7 | 0.734868 | 0.262585 | | | |
| 8 | ∞ | 0.4 | 1.5 | 64 | IR Cut-off |
| | | | | | Filter |
| 9 | ∞ | 0.041937 | | | |
| 10 | ∞ | 0 | | | Image |
| | | | | | Surface |

In Table 1, the first, second, and third lenses 110, 130, and 140 are bi-aspheric lenses, and the image surface refers to the light-receiving surface 162 of the image sensor 160 (that is, the surface of pixel units). If the corresponding optical surface is a plane, the radius of curvature is infinite and the refractive index of the air is 1. The radius of curvature of an aspheric surface refers to a value measured at the center of the aspheric surface. The first, second, and third lenses 110, 130, and 140 and the IR cut-off filter 150 may be formed of commonly used materials, and for example, the first, second, and third lenses 110, 130, and 140 and the IR cut-off filter 150 may be formed of “APEL”, “APEL”, “OKP4HT”, and “BK7_SCHOTT”, respectively.

The aspheric definition equation may be expressed as Equation (1):

$$z = \frac{{ch}^{2}}{1 + SQRT \{ 1 - ( 1 + k ) {c}^{2} {h}^{2} \}} + {Ah}^{4} + {Bh}^{6} + {Ch}^{8} + {Dh}^{10} + {Eh}^{12} + {Fh}^{14} + {Gh}^{16} , \qquad ( 1 )$$

where z indicates a distance from the center (or vertex) of the optical surface along the optical axis 105, h indicates a distance perpendicular to the optical axis 105, c indicates a curvature (an inverse number of a radius of curvature) at the center of the optical surface, SQRT indicates a square root, k indicates a conic coefficient, A, B, C, D, E, F, and G indicate aspheric coefficients, and G=0.

Table 2 provided below shows aspheric coefficients for each aspheric surface of Table 1.

TABLE 2

| Surface | | | | | | | |
|---|---|---|---|---|---|---|---|
| No. | K | A | B | C | D | E | F |
| 1 | −1.41404 | 0.017789 | 0.526599 | −3.68662 | 2.623344 | 4.558215 | −16.9383 |
| 2 | 0 | −0.2841 | −0.82002 | −1.22455 | 6.753719 | 0.045467 | 0.000685 |
| 4 | 0.781796 | −0.59967 | −0.15501 | 30.55036 | 55.04751 | 0.085852 | −9.36E−05 |
| 5 | −1.35746 | 0.316436 | −4.26128 | 9.163845 | 28.40168 | 58.07146 | −270.494 |
| 6 | 0 | −0.37402 | 0.738979 | −0.28733 | −0.69876 | 0.982185 | −0.45549 |
| 7 | −9.20036 | −0.48578 | 0.748663 | −1.05036 | 0.85254 | −0.32041 | 0.024863 |

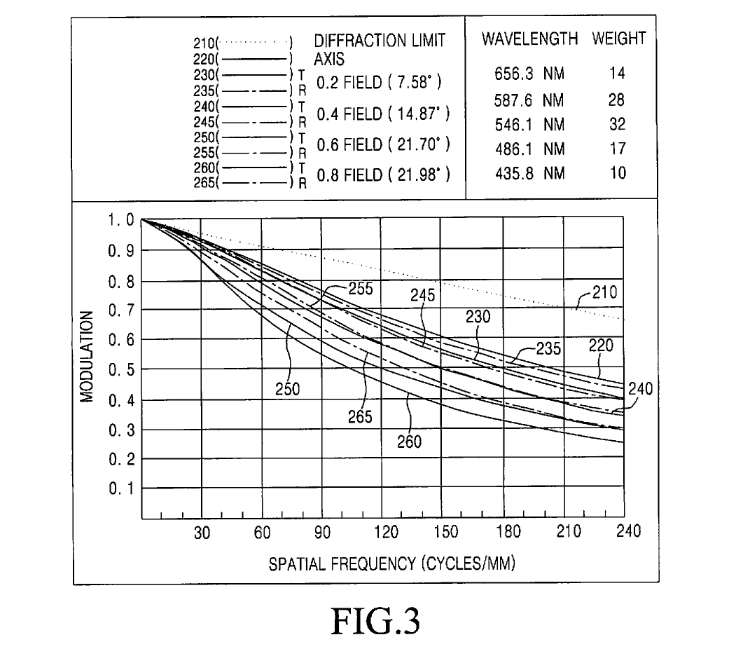

FIG. 3 shows Modulation Transfer Function (MTF) curves of the optical imaging system 100 based on simulations.

In the shown graph, a horizontal axis indicates a spatial frequency expressed in the unit of cycles/mm (or line pair per mm (lp/mm)), and a vertical axis indicates an MTF rate, that is, reproducibility. Cycles/mm or lp/mm indicate how many pairs of white and black lines exist within 1 mm. The MTF rate, that is reproducibility, indicates the degree to which the optical imaging system reproduces a pair of white and black lines. That is, if the optical imaging system completely reproduces a pair of white and black lines, the MTF rate is 1; otherwise, if the optical imaging system fails to reproduce any pair of white and black lines, the MTF rate is 0. Reference numeral 210 indicates a diffraction limit, that is, an ideal MTF curve, and reference numeral 220 indicates an MTF curve at the optical axis position, that is, at the center of the image sensor 160. Reference numerals 230 and 235 indicate vertical direction (T) and horizontal direction (R) MTF curves at a position corresponding to 0.2 of a half of a viewing angle of 7.58° or a total diagonal line length of the image sensor 160 (that is, 0.2 field). Likewise, reference numerals 240 and 245 indicate vertical direction (T) and horizontal direction (R) MTF curves at a viewing angle of 14.87° or 0.4 field. Reference numerals 250 and 255 indicate vertical direction (T) and horizontal direction (R) MTF curves at a viewing angle of 21.70° or 0.6 field. Reference numerals 260 and 265 indicate vertical direction (T) and horizontal direction (R) MTF curves at a viewing angle of 27.98° or 0.8 field. In this simulation, wavelengths of 656.3 nm, 587.6 nm, 546.1 nm, 486.1 nm, and 435.8 nm to which weights of 14, 28, 32, 17, and 10 are approximately applied are used.

A camera mounted in a portable phone tends to be miniaturized, such that the size of an image sensor also tends to be reduced. In a typical portable phone, an image sensor having a diagonal length of ⅙″ or less is used and a pixel size of the image sensor is 1.4 μm or less. The use of the small-size image sensor accompanies a decrease in the pixel size of the image sensor in the same resolution condition, such that the image sensor needs to have a high optical resolution.

This simulation shows MTF performance of an optical imaging system having a 1.3 Mega image sensor (having a pixel size of 1.4 μm).

Referring to FIG. 3, the center portion of the image sensor 160, such as the optical axis position, maintains an MTF rate of 50% or more in 180 lp (or cycle), and the peripheral portion of the image sensor 160, such as 0.8 field, maintains an MTF rate of 30% or more. If the pixel size is changed into 1.1 μm in the same-size image sensor condition, the resolution may increase to 2 Mega and a Nyquist frequency correspondingly changes, such that details of the same image may be equally expressed only when MTF performance is maintained at the foregoing values in 230 lp. However, referring to FIG. 3, it can be seen that the MTF rate in 230 lp is reduced by 10% or more from the MTF rate in 180 lp.

In the present invention, an optical aberration, which is a cause for MTF degradation, is corrected using one cemented lens instead of using a single lens as in the Comparative Example, and an MTF reduction resulting from pixel size reduction may be suppressed. In addition, when a single lens for aberration correction is simply added to the optical system according to the Comparative Example, a lens thickness and an air interval may face limits and a thin edge thickness of a lens may lower the assembly yield of camera lenses. In the present invention, by using a cemented lens, the foregoing problems may be solved.

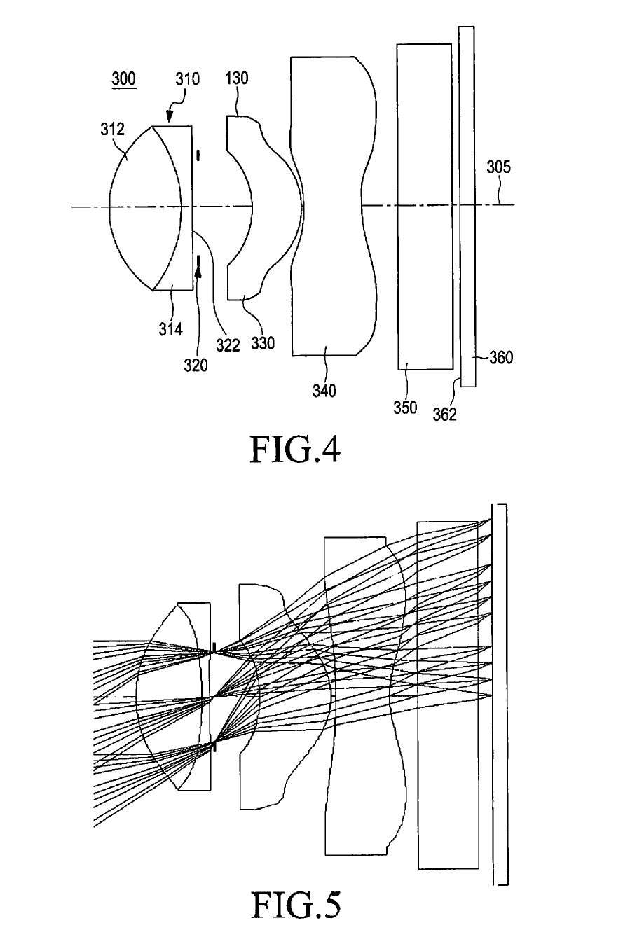

FIG. 4 is a diagram illustrating a structure of an optical imaging system 300 according to an embodiment of the present invention, and FIG. 5 is a diagram illustrating a ray tracing simulation result when the optical imaging system 300 according to the embodiment of the present invention photographs an object.

The optical imaging system 300 includes a first lens 310, an iris 320, second and third lenses 330 and 340, an IR cut-off filter 350, and an image sensor 360, which are aligned on an optical axis 305. Typically, an optical axis refers to an axis which is not optically changed even when an optical device rotates with respect to the axis. Alignment on the optical axis means that a center of curvature of an optical device is situated on the optical axis or a symmetric point (that is, a symmetric center) or center point of the optical device is situated on the optical axis.

The first, second, and third lenses 310, 330, and 340 form an image of an object situated within their angles of view on a light-receiving surface 362 of the image sensor 360, and the IR cut-off filter 350 cuts off an IR signal passing through the first, second, and third lenses 310, 330, and 340. The image sensor 360 converts an optical image formed by the light passing through the IR cut-off filter 350 into an electric image signal.

The image sensor 360 includes a plurality of pixel units arranged in an M×N matrix, and the pixel unit may include a photodiode and a plurality of transistors. The pixel unit accumulates electric charges generated by incident light, and a voltage corresponding to the accumulated electric charges indicates illumination of light. When a still image or an image forming a moving image is processed, an image signal output from the image sensor 360 includes a set of voltages (that is, pixel values) which are output from the pixel units, and the image signal represents one frame (that is, a still image). The frame includes M×N pixels.

Table 3 provided below shows numeric data of optical devices of the optical imaging system 300. Table 3 shows a surface number i, a radius of curvature R of an i^{th} optical surface Sᵢ, a thickness or air interval of the i^{th} optical surface (or a distance from the i^{th} optical surface to an (i+1)^{th} optical surface), T, a refractive index n_{d} in a d-line (587.5618 nm) of the i^{th} optical surface, and a dispersion value in the d-line of the i^{th} optical surface, that is, an Abbe's number, V_{d}. The unit for the radius of curvature and the thickness is mm. The optical surface number i is sequentially added in a direction from the object toward the image sensor (that is, an image surface). For example, in the first lens 310, the first optical surface may be an object-side optical surface and the second optical surface may be an image-side optical surface. The mark “*” in front of the optical surface number i indicates that the corresponding optical surface is aspherical, and the other optical surfaces are spherical. The object is assumed to be a round object situated at infinity. The iris 320 has a circular opening 322.

TABLE 3

| | Radius | | | Abbe's | |
|---|---|---|---|---|---|
| Surface | of Curvature | Surface | Refractive | No. | |
| Number | (R) | Interval | Index (n_{d}) | (V_{d}) | Remarks |
| *1 | 0.861568 | 0.432497 | 1.55 | 56 | First Lens |
| *2 | −1.19918 | 0.05 | 1.63 | 23 | |
| 3 | ∞ | 0.03 | | | |
| 4 | ∞ | 0.345033 | | | Iris |
| *5 | −0.7259 | 0.406892 | 1.55 | 56 | Second |
| | | | | | Lens |
| *6 | −0.41613 | 0.068351 | | | |
| *7 | −21.6424 | 0.313992 | 1.55 | 56 | Third Lens |
| *8 | 0.622648 | 0.246021 | | | |
| 9 | ∞ | 0.4 | 1.5 | 64 | IR Cutoff |
| | | | | | Filter |
| 10 | ∞ | 0.076414 | | | |
| 11 | ∞ | −0.00085 | | | image |
| | | | | | Surface |

In Table 3, first and second optical surfaces of the first lens 310 are aspheric surfaces, the second and third lenses 330 and 340 are bi-aspheric lenses, and the image surface refers to the light-receiving surface 362 of the image sensor 360 (that is, the surface of pixel units). If the corresponding optical surface is a plane, the radius of curvature is infinite and the refractive index of the air is 1. The first, second, and third lenses 310, 330, and 340 and the IR cut-off filter 350 may be formed of commonly used materials. For example, the first lens 310 may be formed of materials such as “APEL” and “OKP4HT”, and the second and third lenses 330 and 340 and the IR cut-off filter 350 may be formed of “APEL”, “APEL”, and “BK7 SCHOTT”, respectively.

The aspheric definition equation may be expressed as Equation (1) as shown above.

Table 4 provided below shows aspheric coefficients for each aspheric surface of Table 3.

TABLE 4

| Surface | | | | | | | |
|---|---|---|---|---|---|---|---|
| No. | K | A | B | C | D | E | F |
| 1 | −0.72809 | 0.084454 | 0.173702 | −0.62865 | 0.248364 | −3.09418 | −9.21737 |
| 2 | −1.19918 | −6.13939 | 0.218825 | 2.980267 | 0 | 0 | 0 |
| 5 | 1.343492 | −0.43958 | −0.13794 | 22.93406 | 61.77659 | 0.016923 | −1.35E−05 |
| 6 | −1.92891 | −0.25289 | −2.60923 | 8.47604 | 18.94093 | 5.446241 | −93.5331 |
| 7 | 0 | −0.62583 | 1.417965 | −1.06171 | −0.488 | 50.452253 | 0.362662 |
| 8 | −8.11357 | −0.58294 | 0.74723 | −0.81895 | 0.408811 | −0.09996 | −0.00229 |

The following description of a form of an optical surface is based on Table 3 and Table 4, but optical surfaces of respective optical devices of the optical imaging system 300 may be spherical or aspherical.

The iris 320 is positioned between the first lens 310 and the second lens 330, and controls the quantity of light incident to the second lens 330 via the circular opening 322 provided in the center portion thereof. In the present embodiment, the iris 320 is positioned in front of the second lens 330, but the iris 320 may also be positioned in front of each lens such as in front of the first lens 310.

In the present invention, the first lens 310 may have a positive (+) refractive power and the second and third lenses 330 and 340 may have positive (+) or negative (−) refractive power, respectively, but the present invention is not limited to this example.

The first lens 310 has a positive (+) refractive power and has first through third optical surfaces which are convex-convex-plane in a direction from an object toward the image sensor 360, and the first and second optical surfaces are aspheric. The first lens 310 is a heterogeneous cemented lens having first, second and third optical surfaces in which a first sub lens 312 and a second sub lens 314 are integrally coupled to each other. the first and second sub lenses 312 and 314 may be formed of plastic materials having different dispersion values such as thermoplastic resin, Ultraviolet (UV) curing resin, or the like. The first sub lens 312 and the second sub lens 314 are directly cemented without interposing any other material, such as an adhesive material or a refractive index matching material, therebetween.

For example, the first sub lens 312 for image formation is injection-molded using thermoplastic resin having a high dispersion value, and the second sub lens 314 for aberration correction is double injection-molded using thermoplastic resin having a low dispersion value, thereby manufacturing the first lens 310.

In addition, for example, the first sub lens 312 for image formation is injection-molded using thermoplastic resin having a high dispersion value, and the second sub lens 314 for aberration correction is molded on the first sub lens 312 by using UV curing resin having a low dispersion value, thereby manufacturing the first lens 310. The UV curing resin is transparent liquid and may preferably have a viscosity of 3000-10000 mpa·s, a refractive index of 1.5-1.7, and a dispersion value of 20-60.

The second lens 330 has a positive (+) refractive power and has fifth and sixth optical surfaces which are bi-concave, and the fifth and sixth optical surfaces are aspheric.

The third lens 340 has a negative (−) refractive power and has seventh and eighth optical surfaces which are convex-concave, and the seventh and eighth optical surfaces are aspheric.

The third lens 340 is a meniscus lens, and the seventh and eighth optical surfaces are concave in their center portions and convex in their peripheral portions.

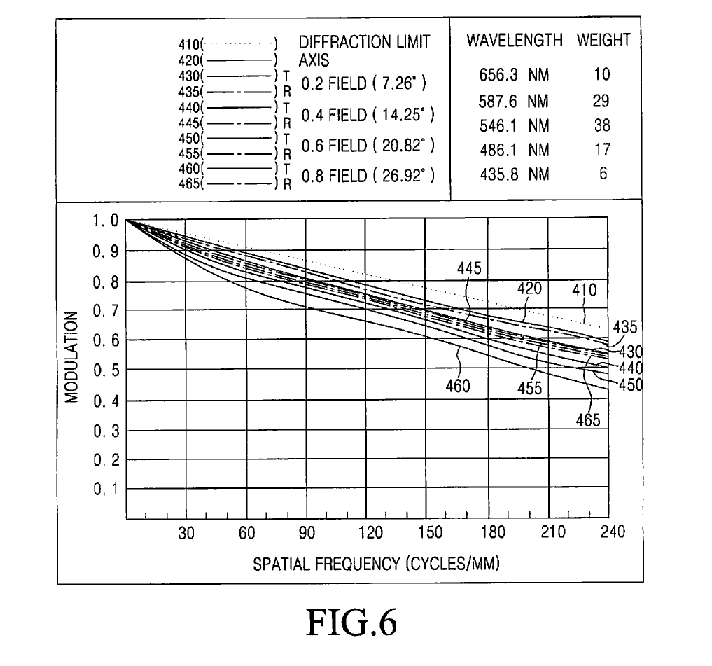

FIG. 6 is a diagram illustrating MTF curves of the optical imaging system 300 based on simulations of an embodiment of the present.

In the shown graph, a horizontal axis indicates a spatial frequency expressed in the unit of cycles/mm (or line pair per mm (lp/mm)), and a vertical axis indicates an MTF rate, that is, reproducibility. Reference numeral 410 indicates a diffraction limit, that is, an ideal MTF curve, and reference numeral 420 indicates an MTF curve at the optical axis position, that is, at the center of the image sensor 360. Reference numerals 430 and 435 indicate vertical direction (T) and horizontal direction (R) MTF curves at a position corresponding to 0.2 of a half of a viewing angle of 7.26° or a total diagonal line length of the image sensor 160 (that is, 0.2 field). Likewise, reference numerals 440 and 445 indicate vertical direction (T) and horizontal direction (R) MTF curves at a viewing angle of 14.25° or 0.4 field. Reference numerals 450 and 455 indicate vertical direction (T) and horizontal direction (R) MTF curves at a viewing angle of 20.82° or 0.6 field. Reference numerals 460 and 465 indicate vertical direction (T) and horizontal direction (R) MTF curves at a viewing angle of 26.92° or 0.8 field. In this simulation, wavelengths of 656.3 nm, 587.6 nm, 546.1 nm, 486.1 nm, and 435.8 nm to which weights of 10, 29, 38, 17, and 6 are approximately applied are used.

This simulation shows MTF performance of an optical imaging system having a 2 Mega image sensor (having a pixel size of 1.1 μm).

Referring to FIG. 6, the center portion of the image sensor 360, such as the optical axis position, maintains an MTF rate of 0.5 (that is, 55%) or more in 230 lp (or cycle), and the peripheral portion of the image sensor 360, such as 0.8 field, maintains an MTF rate of 0.4 (that is, 40%) or more. That is, the optical imaging system 300 according to the present invention shows MTF performance improved when compared to MTF performance of the Comparative Example, and thus may better express details of an image than in the Comparative Example.

As is apparent from the foregoing description, the optical imaging system according to the present invention uses a heterogeneous cemented lens in which first and second sub lenses having different dispersion values are integrally coupled to each other, and is mounted on a portable terminal such as a portable phone, thereby providing higher resolution and higher quality than in conventional optical systems and allowing small size/light weight/low cost.

The present invention is not limited by the foregoing embodiments and the accompanying drawings because various substitutions, modifications, and changes can be made by those of ordinary skill in the art without departing from the spirit of the present invention.

What is claimed is:

1. An optical imaging system comprising:
a first lens having a positive (+) refractive power;
a second lens having a positive (+) or negative (−) refractive power positioned at the rear of the first lens; and
a third lens having a positive (+) or negative (−) refractive power positioned at the rear of the second lens,
wherein the first lens is a heterogeneous cemented lens in which a first sub lens and a second sub lens which have different dispersion values are integrally coupled to each other.

2. The optical imaging system of claim 1, wherein the first sub lens and the second sub lens are formed of plastic materials, and the first sub lens and the second sub lens are directly cemented to each other.

3. The optical imaging system of claim 1, wherein the first sub lens which is positioned further away from the second lens than the second sub lens has a higher dispersion value than a dispersion value of the second sub lens.

4. The optical imaging system of claim 1, wherein the second lens has a positive (+) refractive power and the third lens has a negative (−) refractive power.

5. The optical imaging system of claim 1, further comprising an image sensor for converting an optical image formed by light passing through the first through third lenses into an electric image signal.

6. The optical imaging system of claim 5, further comprising an Infrared (IR) cut-off filter positioned between the third lens and the image sensor to cut off IR signals passing through the first through third lenses.

7. A portable terminal for providing a photographing function, the portable terminal including an optical imaging system, the optical imaging system comprising:
a first lens having a positive (+) refractive power;
a second lens having a positive (+) or negative (−) refractive power positioned at the rear of the first lens; and
a third lens having a positive (+) or negative (−) refractive power positioned at the rear of the second lens,
wherein the first lens is a heterogeneous cemented lens in which a first sub lens and a second sub lens which have different dispersion values are integrally coupled to each other.
